(19) United States
(12) Patent Application Publication
(10) Pub. No.: US 2019/0186586 A1
(43) Pub. Date: Jun. 20, 2019

(54) Bushing

(71) Applicant: ContiTech Vibration Control GbmH, Hannover (DE)

(72) Inventor: Michael Klettke, Hannover (DE)

(21) Appl. No.: 16/328,105

(22) PCT Filed: Jun. 12, 2017
(86) PCT No.: PCT/EP2017/064230

§ 371 Date: Feb. 25, 2019

(30) Foreign Application Priority Data
Aug. 23, 2016 (DE) 10 2016 215 735.3

(51) Int. Cl. F16F 13/14

(52) U.S. Cl. CPC F16F 13/1409; F16F 13/1481; B60G 2204/41062; F16F 2224/02; F16F 2224/0208

(57) ABSTRACT

The present invention relates to a bushing, preferably a hydraulic bushing, having an inner part, an outer part, at least one supporting spring which connects the inner part and the outer part radially to one another, and at least one stop element which is arranged between the inner part and the outer part, is connected to the inner part or the outer part, and is embodied in such a way that the stop element can limit the radial spring travel (D) between the inner part and the outer part in a predetermined fashion. The bushing is characterized in that the stop element is elastically connected to the inner part or to the outer part in such a way that the stop element can be elastically twisted relative to the inner part or relative to the outer part.

### CROSS REFERENCE TO RELATED APPLICATIONS

This application is the national stage of PCT/EP2017/064230, filed Jun. 12, 2017, designating the United States and claiming priority from German patent application no. 10 2016 215 735.3, filed Aug. 23, 2016, the entire contents of which are incorporated herein by reference.

### FIELD OF THE INVENTION

The invention relates to a bushing, preferably a hydraulic bushing, including an inner part and an outer part with a supporting spring radially connecting the inner part and the outer part to each other. A stop element is arranged between the inner part and the outer part. The stop element is connected to the inner part or to the outer part and is configured so as to cause the stop element to limit the radial spring travel between the inner part and the outer part in a predetermined manner.

### BACKGROUND OF THE INVENTION

In the field of vibration-damping devices, inter alia, elastomer bushings which can be used, inter alia, as chassis bearings are known. The devices are usually embodied either as conventional rubber/metal bushings or as hydraulic bushings. In any case, an inner part of the bushing is connected in a radial direction to an outer part via an elastic supporting spring or a pair of elastic supporting springs which are spaced apart in the longitudinal direction, with the result that both radial movements and movements in the longitudinal direction as well as torsion can be absorbed in an elastically damping fashion.

Such bushings and, in particular, hydraulic bushings, can be equipped with stops in order to limit the maximum travel of the spring compression in the radial direction, that is, the spring travel. In this context, a differentiation is made between internal and external stops, wherein the internal stops are arranged in the longitudinal direction between the supporting springs and/or within the fluid chambers, and the external stops are arranged outside.

The stops are usually composed of a strength member which is connected in a fixed fashion to the inner part or to the outer part, and a rubber layer which covers the strength member with respect to the surroundings, such as for example, the fluid chamber. The stop and/or the rubber layer thereof, can come into contact in the radial direction with the inner part or outer part lying opposite and as a result limit the maximum radial spring compression.

It is disadvantageous here that in the case of the maximum radial spring compression, for example, as a result of braking, high torsional forces can also occur simultaneously as result of the spring compression of the wheels. Owing to the resulting torsional stresses with simultaneous high radial stress, the stop and/or the rubber coating thereof can be made to rub against the inner part or outer part lying opposite, or even be sheared off. This can give rise to wear in itself and/or to accelerated wear and can even lead to the destruction of the stop.

In addition, it is disadvantageous with external stops generally that they require a relatively large amount of space, which can adversely affect the size of the working chamber, particularly in the longitudinal direction. This can give rise to a worse performance with respect to the damping properties.

With internal stops it is disadvantageous generally that the available installation space as a rule is limited in the longitudinal direction between elastic supporting springs. This can result in a very high surface pressure for the rubber coating of the stop.

Furthermore, internal stops are as a rule embodied in such way that they are connected to the inner part, which is usually composed of metal. The inner metal part can have, for improving the connection, elevated portions which require either manufacture as a pressure die cast part or as a small tube with an integrally injection molded-on stop contour. It can be disadvantageous in the case of manufacture as a pressure die cast part that as a result the weight of the inner part can be increased, which can have disadvantageous effects on the damping properties of the bushing. It can be disadvantageous in the case of manufacture as a small tube with an integrally injection molded-on stop contour that this can make the manufacture more complex.

If the inner part is configured to absorb high torsional forces in steel, this can lead to the contour of the stop being formed separately and then being fixedly connected to the stop, in order to reduce the weight and/or the costs. However, this can require a complex process for the integral injection molding of a plastic or pressure die cast contour and additionally damage the protection against corrosion.

### SUMMARY OF THE INVENTION

An object of the present invention is to make available a bushing of the type described beginning with an improved service life of the stop. In particular, it is sought to reduce the wear of the stop. This is to be achieved, in particular, as simply and/or cost-effectively as possible. In particular, a large stop face is to be made possible. In particular, such a bushing is to be provided with additional possibilities for adjusting the stop characteristic curve and/or with additional cardanic flexibility of the stop. The intention is to obtain at least one alternative to known bushings.

Bushings are known from the prior art and have the disadvantages described above.

In order to overcome these disadvantages, according to the invention the stop element is elastically connected to the inner part or to the outer part in such a way that the stop element can be elastically twisted relative to the inner part or relative to the outer part. In this context, the dimension of this possible torsion is configured in such a way that when there is contact of the stop element with the inner part and/or the outer part, the relative torsion between the inner part and the outer part can be at least largely, preferably as far as possible completely, absorbed by the elastic connection of the stop element.

In other words, the stop element can make contact with the inner part and/or the outer part, and in the case of torsion which then occurs between the inner part and the outer part these torsional forces can be largely to completely absorbed by means of the elastic connection thereof, with the result that only a small relative movement, extending as far as possible to no relative movement, comes about between the stop element and the inner part with which contact has been made or the outer part with which contact has been made at the contact point. As result, the torsional loading for the stop element can be reduced to completely avoided, with the result that the service life of the stop element can be made longer.

It is also advantageous here that the elastic connection between the stop element and the inner part or outer part can also absorb cardanic stresses, since the stop element can also adapt better to these movements and/or loads. This can also increase the service life of the stop element.

According to one aspect of the present invention, the stop element is connected at least in certain sections, preferably over the entire surface, to the inner part or to the outer part via an elastic connecting layer. The thickness of the connecting layer, that is, the radial extent of the connecting layer, is to be dimensioned here in such a way that the previously described advantageous effect of the absorption of torsion by the connecting layer can be achieved. The connecting layer can for this purpose be provided in certain sections between the stop element and the inner part or the outer part insofar as this is sufficient to achieve the desired effect.

The connecting layer is preferably to be provided over the entire surface between the stop element and the inner part or the outer part, to permit the torsional forces to be absorbed to be distributed as uniformly as possible over the connecting layer. This can also increase the service life of the connecting layer.

It is also advantageous here that the connecting layer can bring about acoustic decoupling. As a result, penetration or passing on an acoustic signal into the vehicle structure can be prevented or at least reduced.

According to a further aspect of the present invention, the stop element has, at least in certain sections and preferably over the entire surface, an elastic outer layer which is oriented radially in the direction of the spring travel. As result, elastic damping and therefore also elastic absorption of torsional forces can therefore additionally also take place on that side of the stop element which radially faces the contact with the inner part or the outer part. This can distribute the torsional loading onto both elastic layers and reduce the elastic connection between the stop element and inner part or outer part, with the result that the elastic connection can hold for longer.

According to a further aspect of the present invention, the elastic outer layer has structuring, which is preferably in the form of radial projections and is configured to deform elastically on contact. As result, the absorption of contact—and in particular of torsional forces—can be improved.

According to a further aspect of the present invention, the stop element is formed substantially in the direction of the spring travel, from two stop regions which lie diametrically opposite one another. In this way, the effect of the stop element can be applied to an amplified degree in this spatial direction.

According to a further aspect of the present invention, the stop element is made narrower substantially perpendicularly with respect to the direction of the spring travel. As result, the effect of the stop element in this spatial direction can be avoided. In addition, as result, a space can be formed within the bushing, in order for example, to arrange the fluid-filled chambers of a hydraulic bushing.

According to a further aspect of the present invention, the inner part and the stop element are composed of different materials. In this way, the damping behaviour of the bushing can be influenced. In particular, the inner part and the stop element can be configured and optimized differently by means of the respective materials. As result, it is also possible, where appropriate, to reduce material costs and/or manufacturing costs.

The article weight can also be influenced positively by this flexibility in the selection of material and in the configuration of the inner part and stop element components.

According to a further aspect of the present invention, the inner part is composed of steel or of aluminum, and the stop element is composed of plastic. As result, the inner part can absorb high loads and the stop element can be embodied in a comparatively lightweight fashion.

According to a further aspect of the present invention, the stop element has at least one passage, preferably a multiplicity of passages, which extends/extend preferably substantially, and particularly preferably entirely, in the longitudinal direction. In this way, the weight of the stop element can be reduced without substantially reducing its stability. In addition, a better connection can be brought about between the stop element and its elastic connection by virtue of the fact that the elastic connecting material can penetrate the passage. If the passage is embodied linearly in the longitudinal direction, this can simplify the manufacture, for example, as an injection molded part or else by means of drilling.

According to further aspect of the present invention, at least one passage is arranged in a first stop region, and at least one passage is arranged in a second stop region. In this way, it is possible to bring about a connection between the stop element and its elastic connection which is as uniform as possible.

According to a further aspect of the present invention, at least one first chamber and one second chamber are embodied between the inner part and the outer part, wherein the two chambers are connected to one another in a media-conducting fashion. As result, additional damping of the bushing can be achieved.

According to a further aspect of the present invention, the two chambers are filled with a fluid. As result, the present invention can be applied to a hydraulic bushing.

The present invention also relates to a chassis or to an assembly having at least one bushing as described above. In this way, the previously described properties and advantages of a bushing according to the invention can be applied to a chassis and/or to an assembly.

The present invention also relates to a vehicle having a chassis and/or having an assembly as described above. In this way, the previously described properties and advantages of a chassis according to the invention and/or of an assembly according to the invention can be applied to a vehicle.

### BRIEF DESCRIPTION OF THE DRAWINGS

The invention will now be described with reference to the drawings wherein:

FIG. 1 shows a schematic illustration of a longitudinal section through a bushing according to the invention from the side; and,

FIG. 2 shows a schematic illustration of a cross section A through a bushing according to the invention.

### DESCRIPTION OF THE PREFERRED EMBODIMENTS OF THE INVENTION

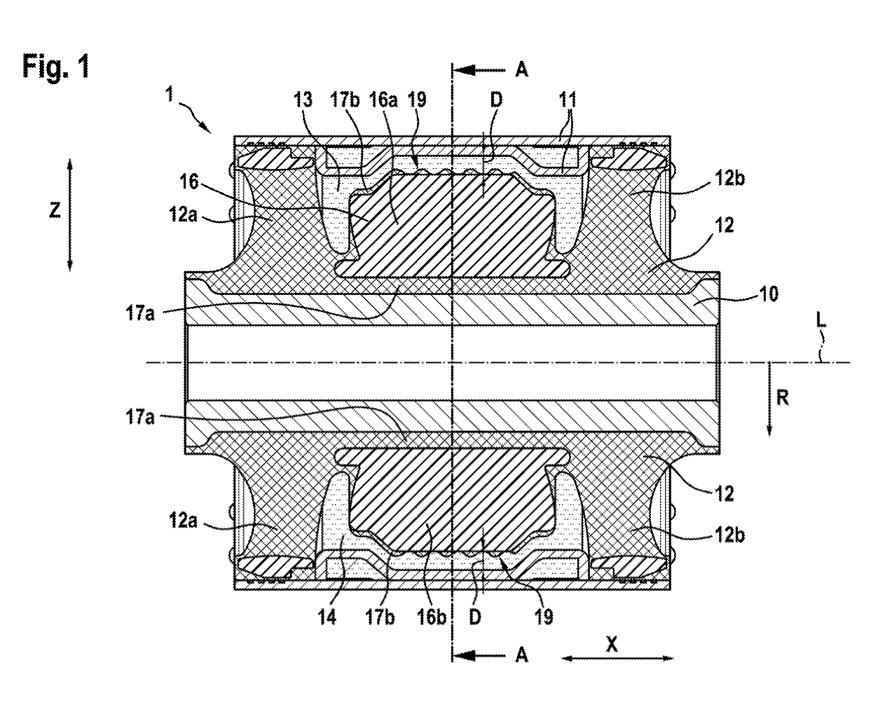

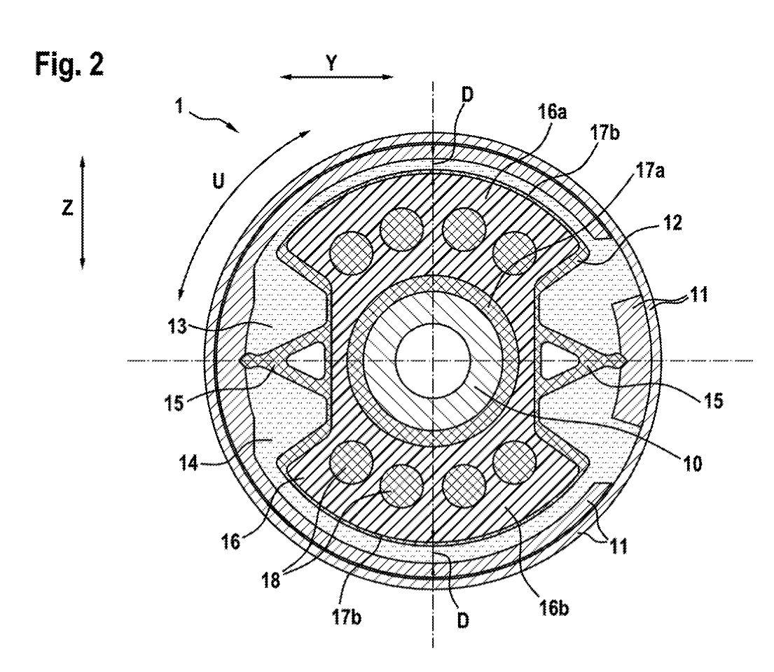

A bushing 1 according to the invention is illustrated in FIGS. 1 and 2 in the Cartesian coordinates of a longitudinal direction X, which can also be referred to as an axial direction X, a transverse direction Y, and a vertical direction Z. The transverse direction Y can also be referred to as a width Y, and the vertical direction Z can also be referred to as a height Z. The bushing 1 has a longitudinal axis L, with respect to which a radial direction R is oriented perpendicularly. A circumferential direction U runs around the longitudinal axis L.

The bushing 1 has an inner part 10 in the form of an inner sleeve 10. The bushing 1 also has an outer part 11 in the form of an outer sleeve 11. Arranged in the height Z between the inner sleeve 10 and the outer sleeve 11 is an elastomer supporting spring 12 which connects the inner sleeve 10 and the outer sleeve 11 elastically to one another in the radial direction R, cf. for example, FIG. 1. The elastomer supporting spring 12 has here in the longitudinal direction X a left-hand supporting spring wall 12a and a right-hand supporting spring wall 12b.

Two fluid-full chambers 13, 14, which are connected in a fluid-conducting fashion to one another (not illustrated) and serve to perform fluidic damping of the bushing 1, are formed in the longitudinal direction X by the two supporting spring walls 12a, 12b and by the inner sleeve 10 and the outer sleeve 11 in the radial direction R. In this context, the first upper fluid chamber 13 is arranged in the height Z above the second lower fluid chamber 14, see for example, FIG. 2. The two fluid chambers 13, 14 are separated from one another by two horizontally running chamber walls 15.

Arranged at the inner sleeve 10, within the two fluid chambers 13, 14, is a stop element 16 which extends radially away from the inner sleeve 10 and as result limits the spring travel D in the radial direction R, by virtue of the fact that the radially outer edge of the stop element 16 can enter into contact with the inner side of the outer sleeve 11. In order to reduce the weight of the bushing 1, the stop element 16 is fabricated from plastic. The inner sleeve 10 is fabricated from steel, in order to be able to absorb relatively high loads. The inner sleeve 10 has at the end side knurl-like toothing arrangements, in order to prevent rotation in the installed state (not illustrated).

The stop element 16 is embedded in the elastic material of the supporting spring 12, in the longitudinal direction X between the two supporting spring walls 12a and 12b, and is completely surrounded by them. In this way, the stop element 16 is elastically connected to the inner sleeve 10 via the elastic material of the supporting spring 12 as an elastic connecting layer 17a. In this context, the elastic connecting layer 17a is dimensioned in respect of its thickness, that is, in the radial direction R, in such a way that when there is contact between the stop element 16 and the inner side of the outer sleeve 11, possible torsional loading relatively between the inner sleeve 10 and the outer sleeve 11 can be as far as possible completely absorbed by the elastic connecting layer 17a. This can relieve the torsional loading acting on the stop element 16 and as a result increase the service life of the stop element 16. In addition, the connecting layer 17a brings about acoustic decoupling, that is, the penetration or passing on of an acoustic signal into the vehicle structure can as a result be prevented or at least reduced.

The elastic material of the supporting spring 12 also surrounds the stop element 16 in such a way that an elastic outer layer 17b of the stop element 16 is also formed, which elastic outer layer 17b performs the contact with the inner side of the outer sleeve 11. As result, torsional loading can also be accommodated elastically. In order to improve this, the elastic outer layer 17b of the stop element 16 has structuring 19 in the form of radial projections 19 which can deform elastically and as a result effectively absorb loading.

This stop element 16 has a first stop region 16a, which is the upper one in terms of the height Z, and a second stop region 16b, which is the lower one in terms of the height Z, with the result that the bushing 1 has an effect of the stop element 16 substantially in terms of the height Z. No stop effect occurs transversely with respect thereto, that is, in the transverse direction Y. The two fluid chambers 13, 14 are substantially arranged in this region.

The two stop regions 16a, 16b each have a multiplicity of passages 18 which run in the longitudinal direction X and are penetrated by the elastic material of the supporting spring 12. As a result, a more durable connection can be produced between the elastic material of the supporting spring 12 and the stop element 16.

In this way, according to the invention a bushing 1 can be formed with an improved service life of the stop element 16. In particular, the wear of the stop element 16 can be reduced. This is done simply and cost-effectively. At the same time, a comparatively large stop surface can be formed. Such a bushing 1 also offers additional possibilities for the adjustment of the stop characteristic curve and additional Cardanic flexibility of the stop element 16.

It is understood that the foregoing description is that of the preferred embodiments of the invention and that various changes and modifications may be made thereto without departing from the spirit and scope of the invention as defined in the appended claims.

### LIST OF REFERENCE NUMERALS:

A Cross section
D Spring travel in the radial direction R
L Longitudinal axis
R Radial direction
U Circumferential direction
X Axial direction; longitudinal direction
Y Transverse direction; width
Z Vertical direction; height
1 (Hydraulically damping) bushing
10 Inner part; inner sleeve
11 Outer part; outer sleeve
12 Elastomer supporting spring
12a Left-hand supporting spring wall
12b Right-hand supporting spring wall
13 First (upper) (fluid) chamber
14 Second (lower) (fluid) chamber
15 Chamber wall between first chamber 13 and second chamber 14
16 Stop element
16a First (upper) stop region of the stop element 16
16b Second (lower) stop region of the stop element 16
17a Elastic connecting layer
17b Elastic outer layer
18 (Longitudinal) passages of the stop element 16
19 Structuring or radial projections of the first stop region 16a or of the second stop region 16b

1-14. (canceled)

15. A bushing comprising:
an inner part;
an outer part;
a supporting spring radially connecting said inner part and said outer part to each other;
a stop element arranged between said inner part and said outer part;
said stop element being connected to said inner part or to said outer part and being configured so as to cause said stop element to limit the radial spring travel (D) between said inner part and said outer part in a predetermined manner; and,
said stop element being elastically connected to one of said parts so as to permit said stop element to elastically twist relative to the other one of said parts.

16. The bushing of claim 15, wherein said stop element is connected to said inner part or to said outer part via an elastic connecting layer at least in sections over a surface.

17. The bushing of claim 15, wherein said stop element is connected to said inner part or to said outer part via an elastic connecting layer over an entire surface.

18. The bushing of claim 15, wherein said stop element has, at least in sections, an elastic outer layer which is oriented radially in the direction of the spring travel (D).

19. The bushing of claim 15, wherein said stop element has, over the entire surface, an elastic layer which is oriented radially in the direction of the spring travel (D).

20. The bushing of claim 17, wherein said elastic outer layer has structuring configured to deform elastically on contact.

21. The bushing of claim 17, wherein said elastic layer has structuring in the form of radial projections and is configured to deform elastically on contact.

22. The bushing of claim 15, wherein said stop element is formed substantially in the direction of said spring travel (D), and forms two stop regions which lie diametrically opposite one another.

23. The bushing of claim 15, wherein said stop element is made narrower substantially perpendicularly with respect to the direction of the spring travel (D).

24. The bushing of claim 15, wherein said inner part and said stop element are made of different materials.

25. The bushing of claim 24, wherein said inner part is made of steel or aluminum and said stop element is made of plastic.

26. The bushing of claim 15, wherein the stop element has at least one passage which extends substantially in the longitudinal direction (X).

27. The bushing of claim 15, wherein said stop element has several passages which extend substantially in the longitudinal direction (X).

28. The bushing of claim 25, wherein at least one passage is arranged in a first stop region and at least one passage is arranged in a second stop region.

29. The bushing of claim 15, wherein at least one first chamber and one second chamber are embodied between said inner part and said outer part; and, the two chambers are connected to one another in a media-conducting manner.

30. The bushing of claim 29, wherein said two chambers are filled with a fluid.

31. A chassis or assembly having at least one bushing as claimed in claim 15.

32. A vehicle having a chassis and/or an assembly as claimed in claim 31.

33. The bushing of claim 15, wherein said bushing is a hydraulic bushing.
